(19) United States
(12) Patent Application Publication
(10) Pub. No.: US 2007/0211502 A1
(43) Pub. Date: Sep. 13, 2007

(54) Voltage step-up circuit and electric appliance therewith

(76) Inventor: Kunihiro Komiya, Kyoto-shi (JP)

Correspondence Address: FISH & RICHARDSON P.C., P.O. BOX 1022, MINNEAPOLIS, MN, 55440-1022, US

(21) Appl. No.: 11/713,192

(22) Filed: Mar. 2, 2007

(30) Foreign Application Priority Data
Mar. 7, 2006 (JP) 2006-060704

(51) Int. Cl. H02M 3/18

(52) U.S. Cl. 363/59

(57) ABSTRACT

A charge-pump voltage step-up circuit that produces a desired output voltage by stepping up an input voltage with an output capacitor combined with a plurality of stages of voltage step-up units has a voltage step-up factor switcher controlling how many stages of the voltage step-up units are operated according to a specified voltage step-up factor and a discharge controller discharging electric charge out of the charge accumulation capacitors and out of the output capacitor before the voltage step-up factor is changed. With this configuration, the voltage step-up factor can be changed without producing a reverse current from the output terminal.

This application is based on Japanese Patent Application No. 2006-060704 filed on Mar. 7, 2006, the contents of which are hereby incorporated by reference.

### BACKGROUND OF THE INVENTION

1. Field of the Invention

The present invention relates to a charge-pump voltage step-up circuit.

2. Description of Related Art

Conventionally, charge-pump voltage step-up circuits are known that produce a desired output voltage Vout by stepping up an input voltage Vin with a circuit configuration as shown in FIG. 8 that includes an output capacitor Co combined with a plurality of stages of voltage step-up units including charge transfer switches (SW1a to SW1c, SW2a to SW2c, and SW3a to SW3d) and charge accumulation capacitors (C1 to C3).

Specifically, with this circuit configuration, a voltage is stepped up in the following manner. First, during the charge period of the capacitor C1, in the first-stage voltage step-up unit, the switches SW1a and SW1b are kept on, and the switch SW1c is kept off; in the second-stage voltage step-up unit, the switch SW2a is kept off. As a result of this switching, the input voltage Vin is applied via the switch SW1a to one terminal (point “a”) of the capacitor C1, and a ground voltage GND is applied via the switch SW1b to the other terminal (point “b”) of the capacitor C1. Thus, the capacitor C1 is charged until the potential across it becomes approximately equal to the input voltage Vin.

After completion of the charging of the capacitor C1, now, in the first-stage voltage step-up unit, the switches SW1a and SW1b are turned off, and the switch SW1c is turned on. As a result of this switching, the potential at point “b” is raised from the ground voltage GND to the input voltage Vin. Here, as a result of the previous charging of the capacitor C1, the potential across it is equal to the input voltage Vin. Thus, when the potential at point “b” raises to the input voltage Vin, simultaneously the potential at point “a” raises to 2Vin (the input voltage Vin plus the charge voltage Vin).

Meanwhile, in the second-stage voltage step-up unit, the switches SW2a and SW2b are kept on, and the switch SW2c is kept on; in the third-stage voltage step-up unit, the switch SW3a is kept off. As a result of this switching, the capacitor C2 is charged until the potential across it becomes approximately equal to 2Vin.

Any succeeding voltage step-up unit repeats similar charging/discharging operations so that eventually, from one terminal of the output capacitor Co, a positive stepped-up voltage 4Vin, i.e., a voltage raised fourfold from the input voltage Vin, is extracted as the output voltage Vout.

Conventionally disclosed and proposed voltage step-up circuits like the one described above include various types that allow their voltage step-up factors to be changed as necessary (e.g., see JP-A-2005-318786).

Even the voltage step-up circuit shown in FIG. 8 can be operated in any of a fourfold, a threefold, and a twofold voltage step-up mode as necessary.

Specifically, to operate the voltage step-up circuit in the fourfold voltage step-up mode, all the stages of the voltage step-up units are driven by performing the above-described switching for all the switches provided. For operation in the threefold voltage step-up mode, the last-stage voltage step-up unit is kept out of operation by keeping the switches SW3b and SW3d on and the switch SW3c off, while the above-described switching is performed for the other switches. For operation in the twofold voltage step-up mode, only the first-stage voltage step-up unit is driven by keeping the switches SW2b, SW3a, SW3b, and SW3d on and the switches SW2c and SW3c off, while the above-described switching is performed for the other switches.

It is true that, with the conventional voltage step-up circuit described above, it is possible to produce a desired output voltage by changing its voltage step-up factor according to, e.g., the status of the load, the variation of the input voltage, or a control signal from the outside.

Inconveniently, however, in the conventional voltage step-up circuit described above, generally the voltage step-up factor is changed while the voltage step-up operation is continued. As a result, in the conventional voltage step-up circuit described above, when the voltage step-up factor is changed from the current factor to a lower factor, a reverse current may flow from the output terminal, i.e., the highest-potential point in the entire system, toward the input terminal, risking the switches provided in the path of the reverse current being exposed to a voltage higher than usual. Thus, in the conventional voltage step-up circuit described above, to avoid breakdown of component elements, all the switches in the path of the reverse current need to be built as elements having a withstand voltage comparable with the output voltage Vout (e.g., in a case where the input voltage Vin is 2.5 V and the output voltage Vout is 10 V, those elements need to have a withstand voltage of 10 V or 15 V). This leads to an unnecessarily large chip area and an unnecessarily high on-state resistance.

### SUMMARY OF THE INVENTION

An object of the present invention is to provide a voltage step-up circuit whose step-up factor can be changed without producing a reverse current from the output terminal, and to provide an electric appliance incorporating such a voltage step-up circuit.

A charge-pump voltage step-up circuit that produces a desired output voltage by stepping up an input voltage with an output capacitor combined with a plurality of stages of voltage step-up units including charge transfer switches and charge accumulation capacitors is provided with: a voltage step-up factor switcher increasing or decreasing the number of stages of the voltage step-up units that are operated according to a specified voltage step-up factor; and a discharge controller discharging electric charge out of the charge accumulation capacitors and out of the output capacitor before the voltage step-up factor is changed.

### BRIEF DESCRIPTION OF THE DRAWINGS

FIG. 1 is a block diagram showing an example of an electric appliance according to the invention;

FIG. 2 is a diagram showing how the high-level potential of a third clock signal CLK3 is varied;

FIG. 3 is a circuit diagram of a voltage step-up circuit, as a first embodiment of the invention;

FIG. 4 is a diagram showing the correlation between voltage step-up factor specifying signals S1 and S2 and a mode control signal SX;

FIG. 5 is a diagram showing voltage step-up factor changing operation in the first embodiment;

FIG. 6 is a circuit diagram of a voltage step-up circuit, as a second embodiment of the invention;

FIG. 7 is diagram showing voltage step-up factor changing operation in the second embodiment; and

FIG. 8 is a circuit diagram of a conventional example of a voltage step-up circuit.

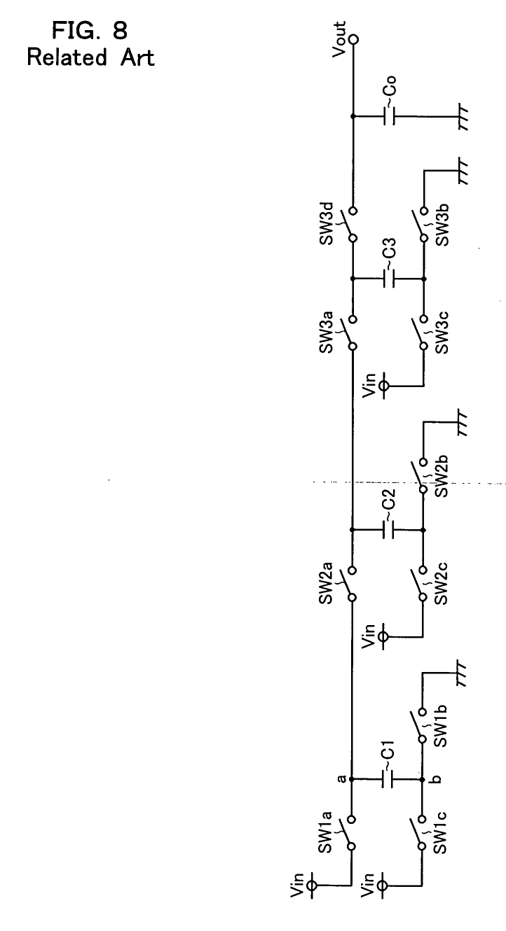

### DETAILED DESCRIPTION OF PREFERRED EMBODIMENTS

Hereinafter, the present invention will be described by way of examples of voltage step-up circuits that are used as means for generating a supply voltage to a clock generator incorporated in various electric appliances (such as portable personal computers and mobile telephone terminals, among others) to generate a clock signal needed for the operation of those electric appliances.

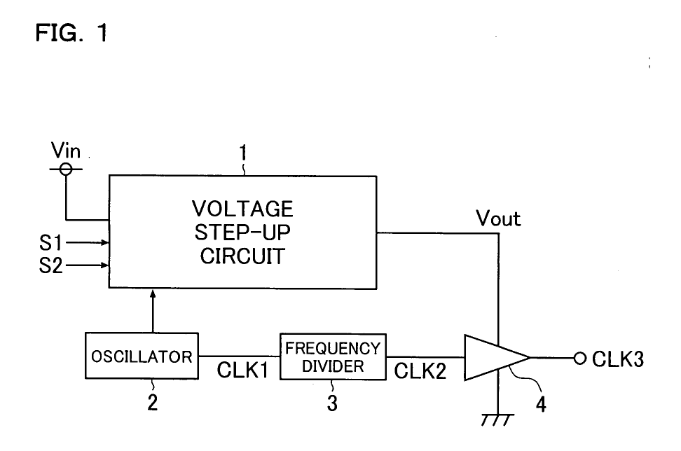

FIG. 1 is a block diagram showing an example of an electric appliance (and, in particular, a clock generator incorporated in it) according to the invention.

The clock generator shown in FIG. 1 includes: a charge-pump voltage step-up circuit 1 that steps up an input voltage Vin and thereby produces a desired output voltage Vout to feed it as a supply voltage to an amplifier 4; an oscillator 2 that produces a first clock signal CLK1; a frequency divider 3 that produces a second clock signal CLK2 by frequency division of the first clock signal CLK1; and an amplifier 4 that produces a third clock signal CLK3 by amplifying the high-level potential of the second clock signal CLK2 to the level of the supply voltage to the amplifier 4 itself (i.e. to the output voltage Vout). The oscillator 2 also serves as means for generating a clock according to which charge transfer switches (unillustrated) provided in the voltage step-up circuit 1 are opened and closed.

In the clock generator configured as described above, according to the logic levels of the voltage step-up factor specifying signals S1 and S2 (both are binary signals), the voltage step-up factor of the voltage step-up circuit 1 can be changed among twofold, threefold, and fourfold on an alternative basis.

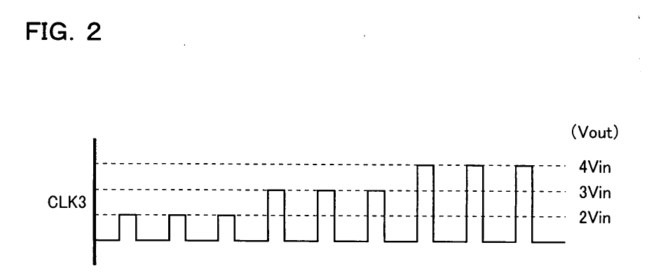

Accordingly, in the clock generator configured as described above, the high-level potential of the third clock signal CLK3 can be changed among 2Vin, 3Vin, and 4Vin on an alternative basis (see FIG. 2). With this configuration, in the electric appliance incorporating the clock generator, according to the operation status of the electric appliance (e.g., whether it is in a power-saving mode or sleep mode or not), the high-level potential of the third clock signal CLK3 can be varied to reduce electric power consumption.

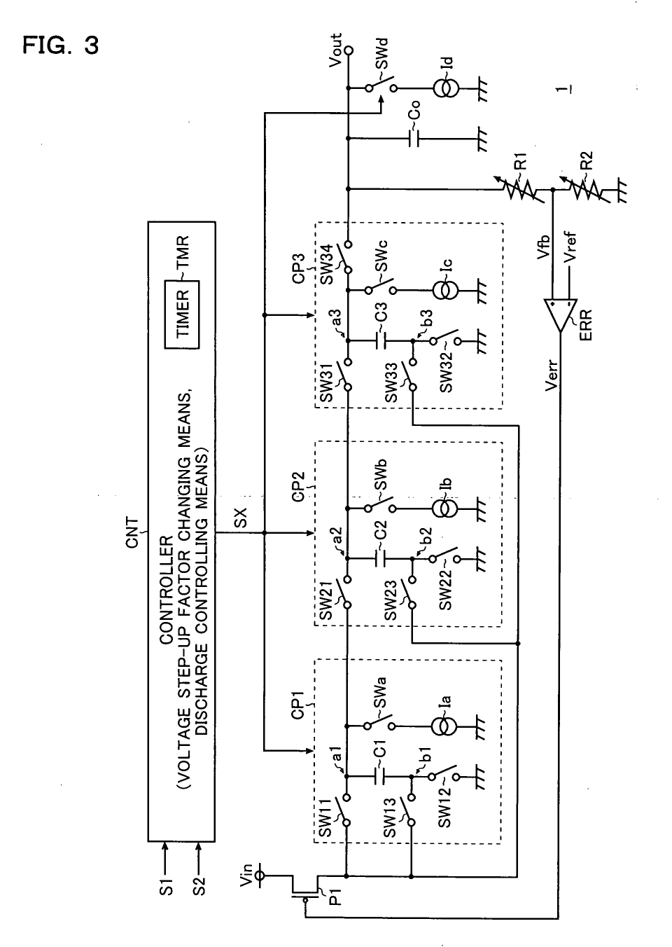

Next, as a first embodiment of the invention, an example of the voltage step-up circuit 1 will be described with reference to FIGS. 3 to 5.

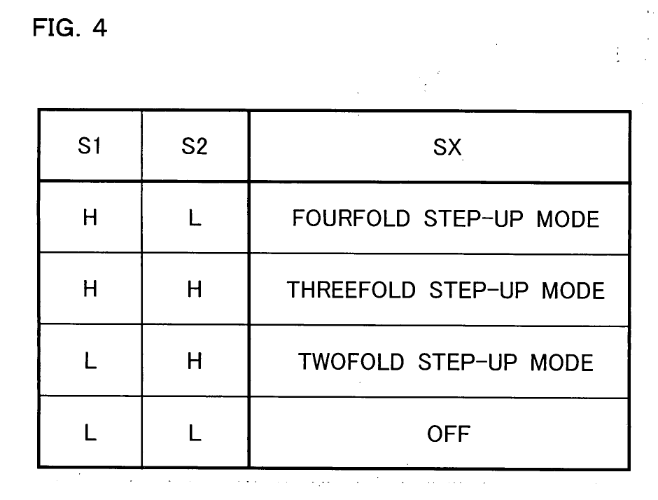

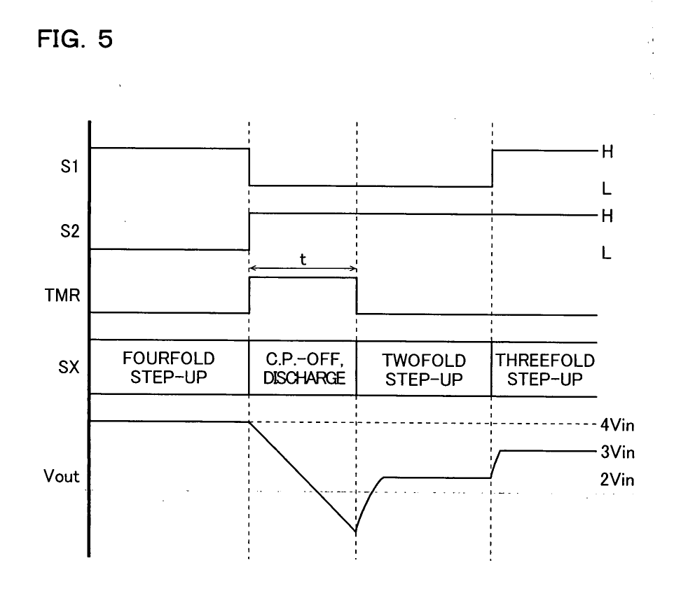

FIG. 3 is a circuit diagram of the voltage step-up circuit 1 of the first embodiment. FIG. 4 is a diagram showing the correlation between the voltage step-up factor specifying signals S1 and S2 and a mode control signal SX. FIG. 5 is a diagram showing the voltage step-up factor changing operation in the first embodiment (this particular diagram shows a change from fourfold to twofold voltage step-up operation).

As shown in FIG. 3, in this embodiment, the voltage step-up circuit 1 includes charge transfer switches SW11 to SW13, SW21 to SW23, and SW31 to SW34, charge accumulation capacitors C1 to C3, an output capacitor Co, discharge switches SWa to SWd, discharge constant-current sources Ia to Id, resistors R1 and R2, an error amplifier ERR, a P-channel field-effect transistor P1, and a controller CNT.

In the voltage step-up circuit 1 configured as described above, a first-stage voltage step-up unit CP1 is formed by the switches SW11 to SW13 and the capacitor C1. One terminal (point “a1”) of the capacitor C1 is connected via the charge transfer switch SW11 to the drain of the transistor P1. The other terminal (point “b1”) of the capacitor C1 is connected via the charge transfer switch SW12 to a ground terminal, and is also connected via the charge transfer switch SW13 to the drain of the transistor P1. The first-stage voltage step-up unit CP1 also includes the switch SWa and the constant-current source Ia, which together serve as means for discharging the capacitor C1. Specifically, one terminal (point “a1”) of the capacitor C1 is connected via the switch SWa and the constant-current source Ia to the ground terminal.

A second-stage voltage step-up unit CP2 is formed by the switches SW21 to SW23 and the capacitor C2. One terminal (point “a2”) of the capacitor C2 is connected via the charge transfer switch SW21 to one terminal (point “a1”) of the capacitor C1. The other terminal (point “b2”) of the capacitor C2 is connected via the charge transfer switch SW22 to the ground terminal, and is also connected via the charge transfer switch SW23 to the drain of the transistor P1. The second-stage voltage step-up unit CP2 also includes the switch SWb and the constant-current source Ib, which together serve as means for discharging the capacitor C2. Specifically, one terminal (point “a2”) of the capacitor C2 is connected via the switch SWb and the constant-current source Ib to the ground terminal.

A last-stage voltage step-up unit CP3 is formed by the switches SW31 to SW34 and the capacitor C3. One terminal (point “a3”) of the capacitor C3 is connected via the charge transfer switch SW31 to one terminal (point “a2”) of the capacitor C2, and is also connected via the charge transfer switch SW34 to a terminal from which the output voltage Vout is extracted. The other terminal (point “b3”) of the capacitor C3 is connected via the charge transfer switch SW32 to the ground terminal, and is also connoted to the charge transfer switch SW33 to the drain of the transistor P1. The last-stage voltage step-up unit CP3 also includes the switch SWc and the constant-current source Ic, which together serve as means for discharging the capacitor C3. Specifically, one terminal (point “a3”) of the capacitor C3 is connected via the switch SWc and the constant-current source Ic to the ground terminal.

One terminal of the output capacitor Co is connected to the terminal from which the output voltage Vout is extracted, and the other terminal of the output capacitor Co is connected to the ground terminal. The output capacitor Co is also connected to the switch SWd and the constant-current source Id, which together serve as means for discharging the output capacitor Co. Specifically, one terminal of the output capacitor Co is connected via the switch SWd and the constant-current source Id to the ground terminal.

Now, a description will be specifically given of how voltage step-up operation (fourfold voltage step-up operation) is performed by the first- to third-stage voltage step-up units CP1 to CP3 and the output capacitor Co. First, during the charging period of the capacitor C1, in the first-stage voltage step-up unit CP1, the switches SW11 and SW12 are kept on, and the switch SW13 is kept off; in the second-stage voltage step-up unit CP2, the switch SW21 is kept off. As a result of this switching, the input voltage Vin is applied via the switch SW11 to one terminal (point “a1”) of the capacitor C1, and a ground voltage GND is applied via the switch SW12 to the other terminal (point “b1”) of the capacitor C1. Thus, the capacitor C1 is charged until the potential across it becomes approximately equal to the input voltage Vin.

After completion of the charging of the capacitor C1, now, in the first-stage voltage step-up unit CP1, the switches SW11 and SW12 are turned off, and the switch SW13 is turned on. As a result of this switching, the potential at point “b1” is raised from the ground voltage GND to the input voltage Vin. Here, as a result of the previous charging of the capacitor C1, the potential across it is equal to the input voltage Vin. Thus, when the potential at point “b1” raises to the input voltage Vin, simultaneously the potential at point “a1” raises to 2Vin (the input voltage Vin plus the charge voltage Vin).

Meanwhile, in the second-stage voltage step-up unit CP2, the switches SW21 and SW22 are kept on, and the switch SW23 is kept on; in the third-stage voltage step-up unit CP3, the switch SW31 is kept off. As a result of this switching, the capacitor C2 is charged until the potential across it becomes approximately equal to 2Vin.

Any succeeding voltage step-up unit repeats similar charging/discharging operations so that eventually, from one terminal of the output capacitor Co, a positive stepped-up voltage 4Vin, i.e., a voltage raised fourfold from the input voltage Vin, is extracted as the output voltage Vout.

The resistors R1 and R2 are connected in series between the terminal from which the output voltage Vout is extracted and the ground terminal, and forms a resistor division circuit that produces a feedback voltage Vfb whose voltage level varies according to the output voltage Vout. The resistors R1 and R2 are so built that their resistances can be varied by trimming or the like as necessary.

The error amplifier ERR serves as means for producing an error voltage Verr by amplifying the difference between the feedback voltage Vfb, which the error amplifier ERR receives at its non-inverting input terminal (±), and a predetermined reference voltage Vref, which the error amplifier ERR receives at its inverting input terminal (−). Specifically, the error voltage Verr is higher the more the feedback voltage Vfb is higher than the reference voltage Vref, and hence the more the output voltage Vout is higher than its target level.

The source of the transistor P1 is connected to the terminal to which the input voltage Vin is applied. The gate of the transistor P1 is connected to the output terminal of the error amplifier ERR. That is, the transistor P1 is serially connected between the terminal to which the input voltage Vin is applied and the first-stage voltage step-up unit CP1, and the on-state resistance of the transistor P1 is varied according to the error voltage Verr. More specifically, since the on-state resistance of the transistor P1 is higher the more the output voltage Vout is higher than its target level, the input voltage Vin applied to the first-stage voltage step-up unit CP1 decreases as the on-state resistance of the transistor P1 increases. With this configuration, the output voltage Vout can be so controlled as to be constantly equal to the desired level.

The controller CNT on one hand functions as voltage step-up factor changing means for increasing or decreasing the number of stages of the voltage step-up units that are operated according to the voltage step-up factor specifying signals S1 and S2 (i.e., the specified voltage step-up factor), and on the other hand functions as discharge controlling means for discharging electric charge out of the charge accumulation capacitors C1 to C3 and out of the output capacitor Co before the voltage step-up factor is changed.

First, a description will be given of how the controller CNT functions as voltage step-up factor changing means.

Based on the correlation shown in FIG. 4, the controller CNT produces the mode control signal SX to select among a fourfold voltage step-up mode, a threefold voltage step-up mode, a twofold voltage step-up mode, and no operation on an alternative basis. Whether the charge transfer switches (SW11 to SW13, SW21 to SW23, and SW31 to SW34) and the discharge switches (SWa to SWd) are clock-driven or not is controlled according to the mode control signal SX produced by the controller CNT.

More specifically, when the fourfold voltage step-up mode is selected, in order to operate all the stages of the voltage step-up units CP1 to CP3, all the charge transfer switches (SW11 to SW13, SW21 to SW23, and SW31 to SW34) are allowed to be clock-driven to perform the above-described switching.

When the threefold voltage step-up mode is selected, in order to stop the last-stage voltage step-up unit CP3, the switches SW32 and SW34 are kept on, and the switch SW33 is kept off, while the above-described switching is performed for the other switches.

When the twofold voltage step-up mode is selected, in order to operate the first-stage voltage step-up unit CP1 alone, the switches SW22, SW31 to SW32, and SW34 are kept on, and the switches SW23 and SW33 are kept off, while the above-described switching is performed for the other switches.

Next, a description will be given of how the controller CNT functions as discharge controlling means.

As shown in FIG. 5, the controller CNT produces the mode control signal SX such that a charge-pump-off (abbreviated to “c. p.-off”) mode (discharge mode) is inserted as an intermediary state before and after a change of the voltage step-up mode. In this intermediary state, in order to stop all the stages of the voltage step-up units CP1 to CP3, the switches SW11, SW13, SW21, SW23, SW31, SW33, and SW34 are all kept off; moreover, in order to connect the other ends of the capacitors C1 to C3 to the ground terminal, the switches SW12, SW22, and SW32 are all kept on. Furthermore, in the intermediary state, in order to discharge electric charge out of the charge accumulation capacitors C1 to C3 and out of the output capacitor Co, the discharge switches SWa to SWd are all kept on.

The insertion of an intermediary state as described above allows the voltage step-up operation to be halted when the voltage step-up factor is changed. With this configuration, it is possible to prevent a reverse current from the output terminal toward the input terminal even when the voltage step-up factor is changed from a current factor to a lower factor. Accordingly, the switches SW11, SW21, SW31, and SW34 and the transistor P1, which could form the path of a reverse current in the conventional configuration, no longer need to be built as high-withstand-voltage elements. Thus, of all the voltage step-up units CP1 to CP3, at least the first-stage voltage step-up unit CP1 can be built with low-withstand-voltage elements. This helps reduce the chip area, and also helps reduce the on-state resistance of the voltage step-up circuit 1.

In the voltage step-up circuit 1 of this embodiment, the controller CNT includes a timer TMR as time counting means so as to discharge electric charge out of the charge accumulation capacitors C1 to C3 and out of the output capacitor Co after an instruction to change the voltage step-up factor is given (after the logic levels of the voltage step-up factor specifying signals S1 and S2 change) until a predetermined time “t” passes thereafter. The predetermined time “t” is set in consideration of variations in the characteristics of component elements (such as variations in the capacitances and current extraction rates of capacitors) so that it is long enough to allow the output voltage Vout to fall to a sufficiently low voltage level (so low that no reverse current is produced). With this configuration, it is possible to realize discharge controlling means extremely easily.

Moreover, in the voltage step-up circuit 1 of this embodiment, the controller CNT discharges electric charge out of the charge accumulation capacitors C1 to C3 and out of the output capacitor Co only when the voltage step-up factor is changed to a factor lower than the current factor. With this configuration, the above-described discharge operation is not performed when the voltage step-up factor is changed in a way involving no risk of producing a reverse current. This allows the voltage step-up operation to be continued without undue delays.

In a case where priority is given to the simplicity of the entire system, however, the charge-pump-off mode (discharge mode) may be inserted every time that the logic levels of the voltage step-up factor specifying signals S1 and S2 change, regardless of the relationship between the voltage step-up factors before and after a change.

Moreover, in the voltage step-up circuit 1 of this embodiment, the discharge controlling means includes the discharge switches SWa to SWd and the discharge constant-current sources Ia to Id, of which one pair of one each is connected in parallel with each of the charge accumulation capacitors C1 to C3 of the voltage step-up units CP1 to CP3 and the output capacitor Co. Here, the constant-current source Id connected to the output capacitor Co produces the maximum discharge current among all the constant-current sources Ia to Id. This configuration including the discharge constant-current sources Ia to Id, as compared with one employing the discharge switches SWa to SWd alone, helps reduce variations in the discharge currents (and hence variations in the discharge times). The reason that the constant-current sources Ia to Id in increasingly posterior stages produce increasingly large currents is that the charge accumulation capacitors C1 to C3 and the output capacitor Co in increasingly posterior stages accumulate increasingly large amounts of electric charge.

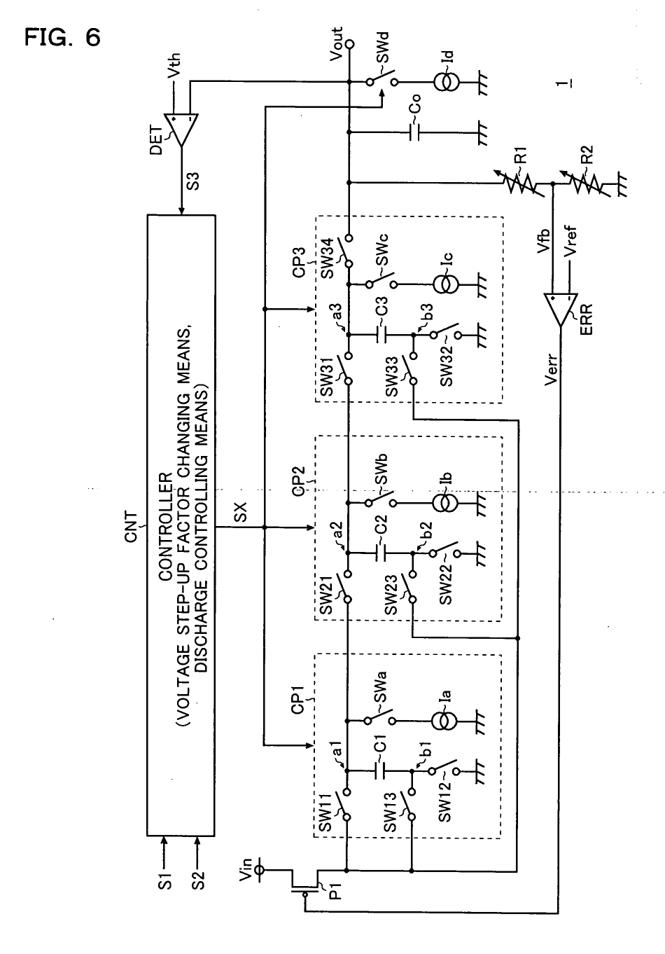

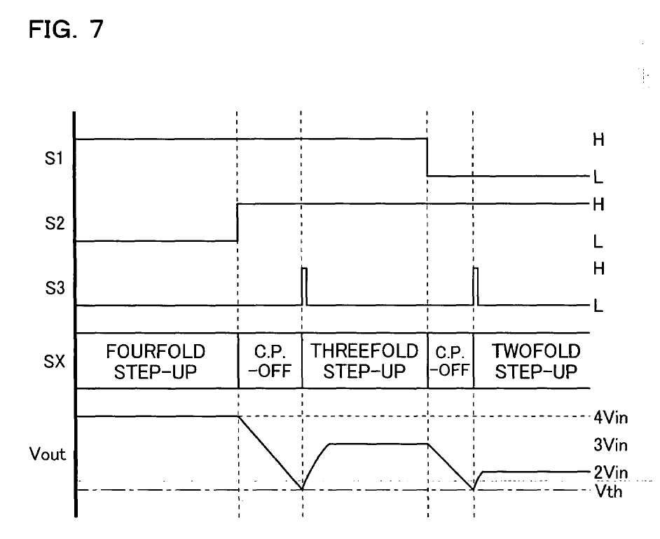

Next, as a second embodiment of the invention, another example of the voltage step-up circuit 1 will be described with reference to FIGS. 6 and 7.

FIG. 6 is a circuit diagram of the voltage step-up circuit 1 of the second embodiment. FIG. 7 is a diagram showing the voltage step-up factor changing operation in the second embodiment (this particular diagram shows a change from fourfold to twofold voltage step-up operation).

The voltage step-up circuit 1 of this embodiment has largely the same configuration as that of the first embodiment described previously. Accordingly, such parts in this embodiment as find their counterparts in the foregoing description are identified with common reference numerals and symbols, and their description will not be repeated. The following description centers around the distinctive features of this embodiment.

As shown in FIG. 6, the voltage step-up circuit 1 of this embodiment additionally includes a detector DET (comparator) that produces a detection signal S3 whose logic level changes according to whether the output voltage Vout is higher than a predetermined threshold voltage Vth or not. Here, based on the detection signal S3, the controller CNT, which functions as discharge controlling means, discharges electric charge out of the charge accumulation capacitors C1 to C3 and out of the output capacitor Co after an instruction to change the voltage step-up factor is given until the output voltage Vout reaches the threshold voltage Vth. The threshold voltage Vth is set equal to the stepped-up voltage after the change of the voltage step-up factor, or to a voltage slightly lower than that in consideration of variations in the characteristics of component element. With this configuration, as compared with that of the first embodiment relying on a timer, it is possible to more accurately set the timing of return from the charge-pump-off mode (discharge mode). This helps prevent excessive lowering of the output voltage Vout, and thus helps improve voltage step-up efficiency.

The embodiments described above deal with, as examples, cases where voltage step-up circuits according to the present invention are applied as means for generating a supply voltage to a clock generator. This however is not meant to limit in any way the application of the present invention; the invention finds wide application in charge-pump voltage step-up circuits in general that produce a desired output voltage by stepping up an input voltage with an output capacitor combined with a plurality of stages of voltage step-up units including charge transfer switches and charge accumulation capacitors.

The embodiments described above deal with, as examples, configurations and operation of positive voltage step-up circuits. This however is not meant to limit in any way the implementation of the present invention; the invention may be applied to negative step-up circuits as well.

The present invention may be practiced in any configurations other than those of the embodiments described above; the invention allows many modifications and variations within its spirit, of which a few examples are as follows.

The embodiments described above deal with, as examples, cases where, in the charge-pump-off mode (discharge mode), electric charge is discharged out of all the charge accumulation capacitors C1 to C3. This however is not meant to limit in any way the configuration of the present invention; charge may be discharged only out of the charge accumulation capacitors of the second-stage and succeeding voltage step-up units. Keeping electric charge in the first-stage voltage step-up unit CP1 even in the charge-pump-off mode (discharge mode) in this way allows early restarting of the voltage step-up operation.

The embodiments described above deal with, as examples, cases where three stages of voltage step-up units are used to allow the voltage step-up factor to be changed among a twofold to a fourfold voltage step-up mode. This however is not meant to limit in any way the configuration of the present invention; the number of stages of voltage step-up units may be reduced to two, or may be increased to four or more.

The embodiments described above deal with, as examples, cases where the voltage step-up factor is changed from a fourfold to a twofold voltage step-up mode. This however is not meant to limit in any way the application of the present invention; an intermediary state may be inserted as described above also when the voltage step-up factor is changed from a fourfold to a threefold voltage step-up mode or from a threefold to a twofold voltage step-up mode.

As described above, with voltage step-up circuits according to the present invention, it is possible to prevent a reverse current from the output terminal when the voltage step-up factor is changed.

From the perspective of industrial applicability, the present invention is useful in charge-pump voltage step-up circuits because it helps improve their reliability without requiring a higher withstand voltage in component elements (and hence an increased chip area).

What is claimed is:

1. A voltage step-up circuit comprising:
a plurality of voltage step-up units including charge transfer switches and charge accumulation capacitors, the voltage step-up units stepping up an input voltage;
an output capacitor connected to an output terminal of a last-stage voltage step-up unit of the voltage step-up units, the output capacitor allowing an output voltage to be extracted from one terminal thereof;
a voltage step-up factor switcher increasing or decreasing the number of stages of the voltage step-up units that are operated according to a specified voltage step-up factor; and
a discharge controller discharging electric charge out of the charge accumulation capacitors and out of the output capacitor before the voltage step-up factor is changed.

2. The voltage step-up circuit of claim 1,
wherein the discharge controller discharges electric charge out of the charge accumulation capacitors and out of the output capacitor after an instruction to change the voltage step-up factor is given until a predetermined time passes thereafter.

3. The voltage step-up circuit of claim 1,
wherein the discharge controller discharges electric charge out of the charge accumulation capacitors and out of the output capacitor after an instruction to change the voltage step-up factor is given until the output voltage reaches a predetermined threshold voltage.

4. The voltage step-up circuit of claim 1,
wherein the discharge controller discharges electric charge out of the charge accumulation capacitors and out of the output capacitor only when the voltage step-up factor is changed to a factor lower than a current factor.

5. The voltage step-up circuit of claim 1,
wherein the discharge controller discharges electric charge only out of second-stage and succeeding voltage step-up units of the charge accumulation capacitors.

6. The voltage step-up circuit of claim 1, further comprising:
a resistor division circuit producing a feedback voltage whose level varies according to the output voltage;
an error amplifier producing an error voltage by amplifying a difference between the feedback voltage and a predetermined reference voltage; and
a transistor connected between a terminal to which the input voltage is applied and a first-stage voltage step-up unit of the voltage step-up units, an on-state resistance of the transistor being varied according to the error voltage.

7. The voltage step-up circuit of claim 1,
wherein at least a first-stage voltage step-up unit of the voltage step-up units is built with low-withstand-voltage elements.

8. The voltage step-up circuit of claim 1,
wherein the discharge controller includes discharge switches and discharge constant-current sources, of which one pair of one each is connected in parallel with each of the charge accumulation capacitors of the voltage step-up units and the output capacitor, the discharge constant-current source connected to the output capacitor producing a maximum discharge current among all the discharge constant-current sources.

9. An electric appliance including a charge-pump voltage step-up circuit,
wherein the voltage step-up circuit comprises:
a plurality of voltage step-up units including charge transfer switches and charge accumulation capacitors, the voltage step-up units stepping up an input voltage;
an output capacitor connected to an output terminal of a last-stage voltage step-up unit of the voltage step-up units, the output capacitor allowing an output voltage to be extracted from one terminal thereof;
a voltage step-up factor switcher controlling how many stages of the voltage step-up units are operated according to a specified voltage step-up factor; and
a discharge controller discharging electric charge out of the charge accumulation capacitors and out of the output capacitor before the voltage step-up factor is changed.

10. The electric appliance of claim 9,
wherein the discharge controller discharges electric charge out of the charge accumulation capacitors and out of the output capacitor after an instruction to change the voltage step-up factor is given until a predetermined time passes thereafter.

11. The electric appliance of claim 9,
wherein the discharge controller discharges electric charge out of the charge accumulation capacitors and out of the output capacitor after an instruction to change the voltage step-up factor is given until the output voltage reaches a predetermined threshold voltage.

12. The electric appliance of claim 9,
wherein the discharge controller discharges electric charge out of the charge accumulation capacitors and out of the output capacitor only when the voltage step-up factor is changed to a factor lower than a current factor.

13. The electric appliance of claim 9,
wherein the discharge controller discharges electric charge only out of second-stage and succeeding voltage step-up units of the charge accumulation capacitors.

14. The electric appliance of claim 9, further comprising:
a resistor division circuit producing a feedback voltage whose level varies according to the output voltage;
an error amplifier producing an error voltage by amplifying a difference between the feedback voltage and a predetermined reference voltage; and
a transistor connected between a terminal to which the input voltage is applied and a first-stage voltage step-up unit of the voltage step-up units, an on-state resistance of the transistor being varied according to the error voltage.

15. The electric appliance of claim 9,
wherein at least a first-stage voltage step-up unit of the voltage step-up units is built with low-withstand-voltage elements.

16. The electric appliance of claim 9,
wherein the discharge controller includes discharge switches and discharge constant-current sources, of which one pair of one each is connected in parallel with each of the charge accumulation capacitors of the voltage step-up units and the output capacitor, the discharge constant-current source connected to the output capacitor producing a maximum discharge current among all the discharge constant-current sources.

17. The electric appliance of claim 9, further comprising:
an oscillator producing a first clock signal;
a frequency divider producing a second clock signal by frequency division of the first clock signal; and
an amplifier producing a third clock signal by amplifying a high-level potential of the second clock signal to a level of a supply voltage to the amplifier itself,
wherein the voltage step-up circuit serves as means for producing the supply voltage to the amplifier.
